(19) United States
(12) Patent Application Publication
(10) Pub. No.: US 2025/0321699 A1
(43) Pub. Date: Oct. 16, 2025

(54) IMAGE FORMING APPARATUS AND INFORMATION PROCESSING DEVICE

(71) Applicant: CANON KABUSHIKI KAISHA, Tokyo (JP)

(72) Inventors: MARIKO SAKAMOTO, Chiba (JP); MASAMI HANO, Chiba (JP); ATSUSHI MATSUMOTO, Ibaraki (JP); KOTA MORI, Chiba (JP); KYOHEI KIKUCHI, Ibaraki (JP); TOSHIYUKI YAMADA, Tokyo (JP)

(21) Appl. No.: 19/171,879

(22) Filed: Apr. 7, 2025

(30) Foreign Application Priority Data
Apr. 12, 2024 (JP) 2024-064420

(51) Int. Cl. G06F 3/12; G03G 15/00

(52) U.S. Cl. CPC G06F 3/1258; G03G 15/502; G03G 15/607; G03G 15/70; G03G 2215/00548

(57) ABSTRACT

An image forming apparatus includes an operation unit configured to allow selection between a first mode for forming an image on a first recording material in which at least one side is closed and a second mode for forming an image on a second recording material without a closed side, and to allow input of information relating to a size of a recording material, an image former configured to form an image on the recording material, and a controller configured to set, in a case where the first mode is selected through the operation unit and a first size is input as information relating to a size of the first recording material, a length of the first recording material in a conveyance direction as a first length.

### BACKGROUND OF THE INVENTION

### Field of the Invention

The present disclosure relates to an image forming apparatus which forms an image on a recording material by using an electrophotographic method or an electrostatic recording method, and to an information processing device.

### Description of the Related Art

An image forming apparatus generally prints images using paper, for example, defined in the Japanese Industrial Standards as a recording material. The image forming apparatus can use various sizes and types of paper or a document folder as the recording material. In Japanese Patent Application Laid-open No. 2011-168394, an image forming apparatus which conveys a document folder is disclosed.

A document folder accommodates standard size paper, and thus is larger in width and length than standard size paper. When an image is formed on such a document folder, it may be determined that a conveyance failure has occurred due to the size of the document folder.

### SUMMARY OF THE INVENTION

An image forming apparatus according to some embodiments of the present disclosure includes an operation unit configured to allow selection between a first mode for forming an image on a first recording material in which at least one side is closed and a second mode for forming an image on a second recording material without a closed side, and to allow input of information relating to a size of a recording material, an image former configured to form an image on the recording material, and a controller configured to set, in a case where the first mode is selected through the operation unit and a first size is input as information relating to a size of the first recording material, a length of the first recording material in a conveyance direction as a first length, and in a case where the second mode is selected through the operation unit and the first size is input as information relating to a size of the second recording material, a length of the second recording material in the conveyance direction as a second length, wherein the first length is longer than the second length.

An image forming apparatus according to another embodiment of the present disclosure includes an operation unit configured to allow selection between a first mode for forming an image on a first recording material in which at least one side is closed and a second mode for forming an image on a second recording material without a closed side, and to allow input of information relating to a size of a recording material, an image former configured to form an image on the recording material, and a controller configured to determine an inter-sheet distance during conveyance based on a reference length obtained by adding a first sheet length of the recording material in a conveyance direction set through the operation unit to an allowable amount of a difference between the first sheet length and a second sheet length in the conveyance direction of an actual recording material, wherein the allowable amount in a case where the first mode is selected through the operation unit is larger than the allowable amount in a case where the second mode is selected through the operation unit.

An information processing device which is communicably connected to an image forming apparatus configured to form an image on a recording material according to yet another embodiment of the present disclosure includes an operation unit configured to allow input of information relating to a size of a recording material, and to allow selection between a first mode for forming an image on a first recording material in which at least one side is closed and a second mode for forming an image on a second recording material without a closed side, and a controller configured to set, in a case where the first mode is selected through the operation unit and a first size is input as information relating to a size of the first recording material, a length of the first recording material in a conveyance direction as a first length, and in a case where the second mode is selected through the operation unit and the first size is input as information relating to a size of the second recording material, a length of the second recording material in the conveyance direction as a second length, wherein the first length is longer than the second length.

An information processing device which is communicably connected to an image forming apparatus configured to form an image on a recording material according to yet another embodiment of the present disclosure includes an operation unit configured to allow input of information relating to a size of a recording material, and to allow selection between a first mode for forming an image on a first recording material in which at least one side is closed and a second mode for forming an image on a second recording material without a closed side, and a controller configured to determine an inter-sheet distance based on a reference length obtained by adding a first sheet length of the recording material in a conveyance direction set through the operation unit to an allowable amount of a difference between the first sheet length and a second sheet length in the conveyance direction of an actual recording material, wherein the allowable amount in a case where the first mode is selected through the operation unit is a value larger than the allowable amount in a case where the second mode is selected through the operation unit.

Further features of the present invention will become apparent from the following description of exemplary embodiments (with reference to the attached drawings).

### BRIEF DESCRIPTION OF THE DRAWINGS

FIG. 1 is a configuration view of an image forming system.

FIG. 2 is an exemplary view for illustrating a comparison of the size between a document folder and a sheet.

FIG. 3 is an explanatory diagram of a main controller.

FIG. 4 is a configuration explanatory view of an operation unit.

FIG. 5 is a configuration diagram of an image forming apparatus.

FIG. 6 is an exemplary view of a sheet type selection screen.

FIG. 7 is a flowchart for illustrating processing up to the start of image forming processing.

FIG. 8 is an exemplary view of a standard size setting screen.

FIG. 9A and FIG. 9B are exemplary views of a guide screen.

FIG. 10 is an exemplary view of an instruction screen.

FIG. 11 is an exemplary view of an original size and duplex printing setting screen.

FIG. 12A and FIG. 12B are explanatory tables of verification results.

FIG. 13 is a flowchart for illustrating processing up to the start of image forming processing.

FIG. 14A and FIG. 14B are explanatory tables of verification results.

### DESCRIPTION OF THE EMBODIMENTS

Now, referring to the accompanying drawings, description is given of at least one exemplary embodiment of the present disclosure. In the at least one embodiment, description of an electrophotographic image forming apparatus is given as an example, but the present disclosure is effective even for other types of image forming apparatus, such as an inkjet type apparatus.

FIG. 1 is a configuration view of an image forming system including an image forming apparatus according to the at least one embodiment. An image forming system 1X includes an image forming apparatus 100 which forms a toner image on a recording material S, and an operation unit 110 which has a display 111. The image forming system 1X may include other back-end process units such as a relay apparatus and a finisher apparatus.

The relay apparatus is arranged between the image forming apparatus 100 and various front-end or back-end process units. The relay apparatus reverses the recording material S conveyed from the image forming apparatus 100 and conveys the reversed recording material S to the front-end or back-end process unit, or temporarily stacks the recording material S and conveys the stacked recording material S to the front-end or back-end process unit. The finisher apparatus performs post-processing, such as punching processing of punching holes in the recording material S or stapling processing of bundling and stapling together a plurality of sheets of the recording material S, and delivers a post-processed bundle of sheets of the recording material S to a delivery tray. In addition to such back-end process units, the image forming system 1X may include, for example, a recording material feeding device which internally accommodates a large amount of the recording material S and feeds an accommodated recording material S to the image forming apparatus 100.

### Image Forming Apparatus

The image forming apparatus 100 according to the at least one embodiment is an electrophotographic tandem full-color printer. The image forming apparatus 100 may be configured to form images using an electrostatic recording method. The image forming apparatus 100 includes, as an image former, an image forming unit Pa for forming a yellow image, an image forming unit Pb for forming a magenta image, an image forming unit Pc for forming a cyan image, and an image forming unit Pd for forming a black image.

The image forming apparatus 100 forms a toner image on the recording material S based on data relating to the toner image included in image data, which is acquired from an external device 1000 such as an original reading apparatus (not shown) or a personal computer communicably connected to the image forming apparatus 100, for example. Examples of materials that can be used as the recording material S include a sheet made of paper, such as general plain paper, cardboard, rough paper, textured paper, and coated paper, as well as, in the at least one embodiment, a document folder having a bag shape formed from a sheet material made of plastic. The document folder has a bag shape, and thus can accommodate sheets.

The document folder has, for example, at least one side open and the remaining sides (edges) closed among a plurality of sides (edges) overlapping by folding a sheet material of a plastic material. That is, the document folder has at least one closed side. The open side (edge) is referred to as “open portion,” and the closed side (edge) is referred to as “fixed portion.” The fixed portion includes a folded portion formed by folding the plastic material, and a closed portion in which the side (edge) has been fixed by a welding method using heat or ultrasonic waves or by a bonding method using an adhesive, for example. Normally, two sides intersecting with each other of the document folder are fixed and closed, and the remaining two sides are open.

Description is now given of a conveyance process of the recording material S. The recording material S is accommodated and placed in a cassette 10, or is placed on a tray 17. The recording material S is fed from the cassette 10 or the tray 17 by feed rollers 13 in accordance with the image forming timing. The tray 17 is provided so as to be openable and closable by a user, for example. The recording material S fed by the feed rollers 13 is conveyed to registration rollers 12 arranged along a conveyance path 114. The registration rollers 12 perform skew correction and timing correction, and then convey the recording material S to a secondary transfer unit T2. The secondary transfer unit T2 is a transfer nip unit formed by an inner secondary transfer roller 14 and an outer secondary transfer roller 11. The secondary transfer unit T2 transfers the toner image onto the recording material S by applying a secondary transfer voltage to the outer secondary transfer roller 11.

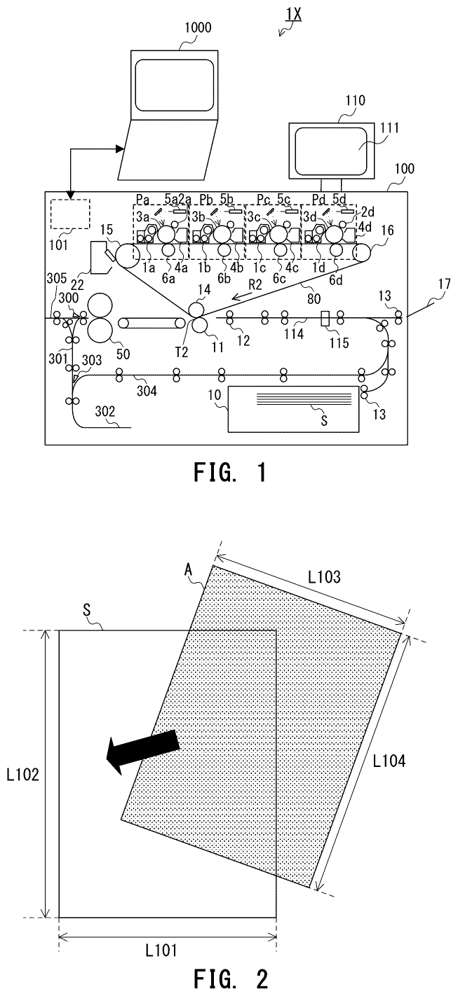

When the actual length of the recording material S in the conveyance direction (hereinafter referred to as “sheet length”) is different from the length that is set, it becomes difficult to form an image at a predetermined position on the recording material S, and jamming of the recording material S occurs. For example, in order to accommodate standard size paper, a document folder is larger in size (width and length) than the standard size. Generally, a document folder is designed to be larger in length and width, for example, by from 5 mm to 15 mm, than standard size paper. As a result, sheets are accommodated without protruding from the document folder. FIG. 2 is an exemplary view for illustrating a comparison of the size between a document folder and a sheet. The recording material S, which is a document folder, is larger in size than a standard size sheet A (L101>L103, L102>L104). Therefore, in a case where the document folder is conveyed with the paper length set to L103, the actual paper length is L101, and hence there is a higher possibility that jamming is detected for the document folder than for the standard size paper.

The allowable amount of the difference between the actual sheet length of the recording material S and the set sheet length within which an image can be formed at a predetermined position is referred to as “jam margin.” In the at least one embodiment, a detector 115 for detecting the actual sheet length of the recording material S is arranged on the conveyance path 114 upstream of the registration rollers 12 in the conveyance direction. When the sheet length detected by the detector 115 is longer than a length obtained by adding a jam margin to the sheet length corresponding to the size of the set recording material S (hereinafter referred to as “jam reference length”), jamming is detected.

In the at least one embodiment, the jam margin is 5 mm. For example, in a case where an A4 standard size having a sheet length of 297 mm is set, the jam reference length is 302 mm. A document folder for A4 standard size is longer than the sheet length for A4 standard size, for example, the sheet length is 310 mm, because it is required to accommodate A4 standard size sheets. When such a document folder is conveyed as an A4 standard size recording material S, the sheet length detected by the detector 115 is longer than the jam reference length. Therefore, jamming is detected.

With the increase in the jam reference length (jam margin), jamming is no longer detected even when a document folder for A4 standard size is conveyed as A4 standard size. However, in this case, a conveyance interval (inter-sheet distance) during conveyance of the document folder becomes larger, which may reduce productivity. Therefore, the jam reference length is required to be set optimally.

In the at least one embodiment, the detector 115 detects passage of the leading edge and the trailing edge of the recording material S being conveyed in the conveyance direction. A distance from the leading edge to the trailing edge (d=t×v) of the recording material S is calculated based on a passage time (t) from passage of the leading edge until passage of the trailing edge and a conveyance speed (v) of the recording material S. This distance (d) is detected as the actual sheet length of the recording material S. The sheet length of the recording material S may be detected by using another method.

Description is now given of the image forming process in which the toner image is conveyed to the secondary transfer unit T2 at the same timing relative to the process of conveying the recording material S to the secondary transfer unit T2. Description is given of the configuration of the image forming units Pa, Pb, Pc, and Pd. The image forming units Pa, Pb, Pc, and Pd have substantially the same configuration, except that the colors of the images (toner images) to be formed are different among yellow, magenta, cyan, and black. Here, description is given of the image forming unit Pd which forms a black toner image, and description of the other image forming units Pa, Pb, and Pc is omitted.

The image forming unit Pd mainly includes a developing device 1d, a charging device 2d, a photosensitive drum 3d, a photosensitive drum cleaner 4d, an exposure device 5d, a primary transfer roller 6d, and the like. The photosensitive drum 3d is a photosensitive member having a photosensitive layer on a surface, and is rotated around a drum shaft. The charging device 2d uniformly charges the surface of the photosensitive drum 3d being rotated. The exposure device 5d forms an electrostatic latent image by irradiating the charged surface of the photosensitive drum 3d with a laser beam which is driven based on an image signal. The developing device 1d forms a black toner image on the surface of the photosensitive drum 3d by using a developer to develop the electrostatic latent image formed on the photosensitive drum 3d.

The primary transfer roller 6d is provided so as to sandwich an intermediate transfer belt 80 at a position opposing the photosensitive drum 3d. The primary transfer roller 6d transfers the toner image formed on the photosensitive drum 3d onto the intermediate transfer belt 80 by applying a primary transfer voltage. Transfer residual toner remaining on the photosensitive drum 3d after the transfer is collected by the photosensitive drum cleaner 4d.

In the same manner, a yellow toner image is formed on a photosensitive drum 3a of the image forming unit Pa, and the toner image is transferred onto the intermediate transfer belt 80 by a primary transfer roller 6a. A magenta toner image is formed on a photosensitive drum 3b of the image forming unit Pb, and the toner image is transferred onto the intermediate transfer belt 80 by a primary transfer roller 6b. A cyan toner image is formed on a photosensitive drum 3c of the image forming unit Pc, and the toner image is transferred onto the intermediate transfer belt 80 by a primary transfer roller 6c.

The intermediate transfer belt 80 is an endless belt stretched around the inner secondary transfer roller 14 and tensioning rollers 15 and 16, and is driven in the direction of an arrow R2. In the at least one embodiment, the tensioning roller 16 also serves as a drive roller which drives the intermediate transfer belt 80. The image forming process of each of the image forming units Pa to Pd is performed at a timing such that the transferred toner images of the respective colors are sequentially superimposed on the intermediate transfer belt 80. As a result, in the end, a full-color toner image is formed on the intermediate transfer belt 80.

The intermediate transfer belt 80 conveys the toner image to the secondary transfer unit T2 by rotating. Conveyance of the toner image to the secondary transfer unit T2 is performed in accordance with the timing at which the recording material S is conveyed to the secondary transfer unit T2. As a result, the toner image is transferred onto a predetermined position on the recording material S. Transfer residual toner remaining on the intermediate transfer belt 80 after the transfer by the secondary transfer unit T2 is removed by a transfer cleaner 22.

The toner image is borne on the recording material S by a conveyance process and an image forming process such as those described above. The recording material S is conveyed from the secondary transfer unit T2 to a fixing device 50. The fixing device 50 fixes the toner image on the recording material S by applying heat and pressure to the recording material S bearing the toner image. For this purpose, the fixing device 50 has a first roller that includes a built-in heat source and a second roller that is biased toward the first roller, and conveys the recording material S by sandwiching the recording material S between the first roller and the second roller. At this time, the recording material S is heated by the heat source and pressed by the second roller. As a result, each toner image borne by the recording material S is melted and mixed, and is fixed on the recording material S as a full-color image.

The recording material S on which the image has been fixed is guided by a flapper 300 to any one of a conveyance path 301 and a conveyance path 305. The flapper 300 guides the recording material S to the conveyance path 305 in a case where the printing surface (image forming surface) is not reversed in simplex printing and in a case where printing on both surfaces is finished in duplex printing. The recording material S guided to the conveyance path 305 is delivered to outside the image forming apparatus 100.

The flapper 300 guides the recording material S to the conveyance path 301 in a case where printing on the front surface (first surface) is finished in duplex printing and in a case where the printing surface is reversed in simplex printing to deliver the recording material S. The recording material S is conveyed to a reversing unit 302 via the conveyance path 301. The conveyance direction of the recording material S conveyed to the reversing unit 302 is reversed, and the recording material S is guided by the flapper 303 to any one of the conveyance path 301 and a duplex-printing conveyance path 304. Through reversing the conveyance direction by the reversing unit 302 and conveying the recording material S to the conveyance path 301 or the duplex-printing conveyance path 304, the printing surface of the recording material S is reversed.

The flapper 303 guides the recording material S to the conveyance path 301 when reversing the printing surface in simplex printing to deliver the recording material S. The recording material S guided to the conveyance path 301 is delivered from the conveyance path 301 to outside the image forming apparatus 100 via the conveyance path 305. The flapper 303 guides the recording material S to the duplex-printing conveyance path 304 in a case where duplex printing on the front surface is finished. The recording material S guided to the duplex-printing conveyance path 304 is conveyed to the secondary transfer unit T2. As a result, an image is printed on the back surface (second surface) of the recording material S.

The developer to be used in the at least one embodiment is a two-component developer containing a toner and a carrier. The toner contains a binder resin, a colorant, and a release agent (wax). A publicly-known binder resin may be used as the binder resin. For example, a vinyl-based copolymer typified by a styrene-(meth)acrylic copolymer, a polyester resin, a hybrid resin in which a vinyl-based copolymer unit and a polyester unit are chemically bonded to each other, an epoxy resin, or a styrene-butadiene copolymer may be used as the binder resin. A publicly-known colorant may be used as a colorant for each of the colors of yellow, magenta, cyan, and black.

For example, an aliphatic hydrocarbon-based wax or an oxide of an aliphatic hydrocarbon-based wax, or a block copolymerized product thereof may be used as the release agent. The aliphatic hydrocarbon-based wax is, for example, low-molecular-weight polyethylene, a low-molecular-weight olefin copolymer wax, a microcrystalline wax, a Fischer-Tropsch wax, or a paraffin wax. The oxide of the aliphatic hydrocarbon-based wax is, for example, a polyethylene oxide wax. The block copolymerized product is a wax containing a fatty acid ester as a main component, an ester wax, or a product obtained by deacidifying part or whole of a fatty acid ester such as deacidified carnauba wax. Examples of the wax containing a fatty acid ester as a main component include a carnauba wax and a montanoic acid ester wax. The ester wax is, for example, a synthesis reaction product of a higher fatty acid and a higher alcohol, such as behenyl behenate or behenyl stearate.

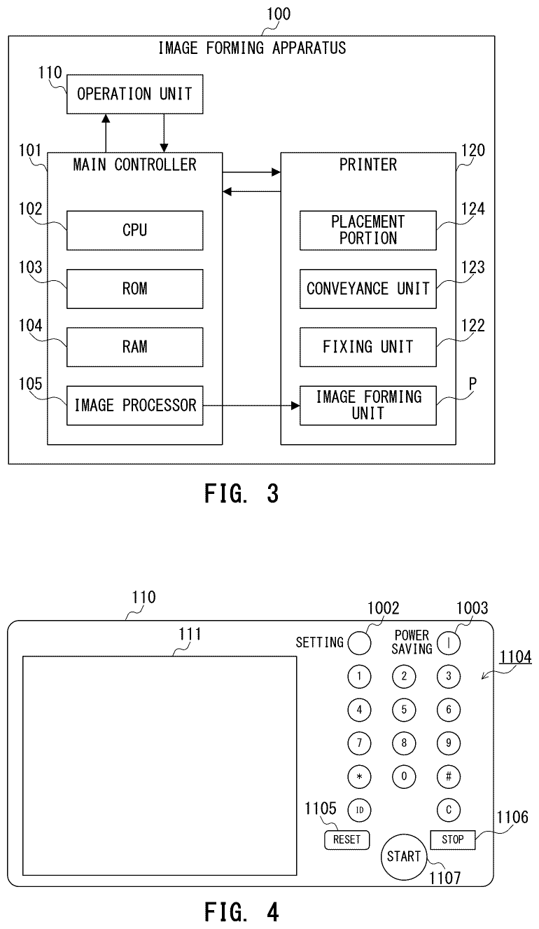

Operation of such an image forming apparatus 100 is controlled by a main controller 101. FIG. 3 is an explanatory diagram of the main controller 101. The main controller 101 can communicate to and from a printer 120 and the operation unit 110. The printer 120 includes various units used in the image forming process described above.

The main controller 101 includes a central processing unit (CPU) 102, a read-only memory (ROM) 103, a random-access memory (RAM) 104, and an image processor 105. The CPU 102 controls the overall operation of the image forming system 1X by executing computer programs stored in the ROM 103. The RAM 104 provides a work area in a case where the CPU 102 executes processing. The image processor 105 transmits, to the image forming units Pa to Pd, an image signal generated by performing predetermined image processing on image data acquired from the external device 1000, such as converting the image data into a format that can be processed by exposure devices 5a to 5d of the image forming units Pa to Pd. Further, the main controller 101 detects jamming in a case where the sheet length detected by the detector 115 is longer than the jam reference length.

The printer 120 includes a placement portion 124, a conveyance unit 123, a fixing unit 122, and an image forming unit P. The image forming unit P represents the above-mentioned image forming units Pa to Pd. The placement portion 124 is the cassette 10 and the tray 17, and the recording material S is accommodated or placed therein. The conveyance unit 123 feeds the recording material S from the placement portion 124, conveys the recording material S to the secondary transfer unit T2 and the fixing device 50, and delivers the recording material S to outside the image forming system 1X. The conveyance unit 123 includes the feed rollers 13, the registration rollers 12, the flappers 300 and 303, and the like. The fixing unit 122 is the above-mentioned fixing device 50, and fixes the toner image on the recording material S. The image forming unit P forms the toner images of the respective colors as described above. The image forming unit P controls the drive of the laser beams output from the exposure devices 5a to 5d based on the image signal acquired from the image processor 105.

In order to perform optimal print settings, the image forming apparatus 100 according to the at least one embodiment is required to set the sheet type based on an instruction from the user by using the operation unit 110. The operation unit 110 is a user interface having an input interface and the display 111 being an output interface. The operation unit 110 is used, for example, to acquire the sheet type setting of the recording material S used for image formation. FIG. 4 is a configuration explanatory view of the operation unit 110.

The operation unit 110 in the at least one embodiment has, as input interfaces, a setting key 1002, a power saving key 1003, a hard key group 1104, a reset key 1105, a stop key 1106, and a start key 1107. Further, the operation unit 110 may include a touch panel provided on the display 111 as an input interface. Content (for example, information required for creating job information such as the type of the recording material S, the number of print copies, and output attribute information) input by using the input interfaces is transmitted to the CPU 102. The user can input information by using the input interfaces.

The setting key 1002 is pressed in a case where various settings such as the sheet type setting are performed. The power saving key 1003 is pressed in a case where the image forming apparatus 100 is set to a sleep mode or woken up from the sleep mode. The image forming apparatus 100 transitions to the sleep mode in a case where the power saving key 1003 is pressed in a normal mode, and transitions to the normal mode in a case where the power saving key 1003 is pressed in the sleep mode. The hard key group 1104 includes a numeric keypad, a clear key, and an authentication key. The reset key 1105 is pressed in a case where various settings are reset. The stop key 1106 is pressed in a case where an operation in progress is stopped. The start key 1107 is pressed in a case where a printing operation is started or in a case where another function is instructed to start. The start key 1107 includes two-color light emitting diodes (LEDs), which are green and red LEDs (not shown). When the start key 1107 is lit in green, this indicates that it is possible to start, and in a case where the start key 1107 is lit in red, this indicates that it is not possible to start.

The various keys described above are hardware keys, but those various keys may be implemented by software keys displayed on the display 111. Further, the various keys may be implemented by combining hardware keys and software keys.

### Examples of Other Image Forming Apparatus

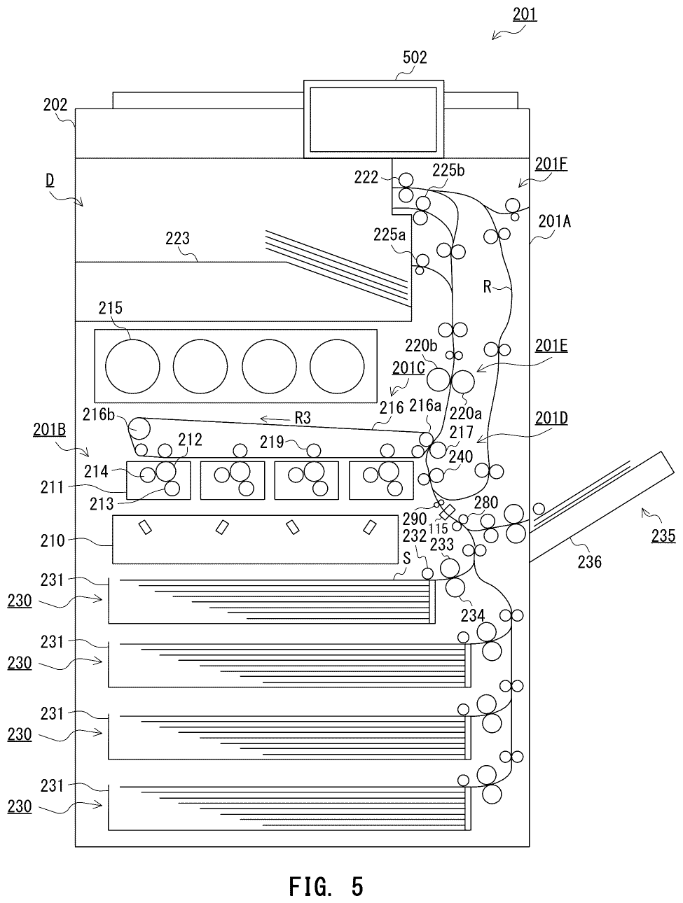

The image forming apparatus 100 described with reference to FIG. 1 prints an image while conveying the recording material S in a horizontal direction horizontal to the lower surface of the image forming apparatus 100. That is, the conveyance path 114 along which the recording material S is conveyed is a horizontal path extending in the horizontal direction. Among image forming apparatus, there are image forming apparatus which print (vertical path) images while conveying the recording material S in a perpendicular direction (vertical direction) orthogonal to the lower surface of the image forming apparatus. FIG. 5 is a configuration view of such an image forming apparatus. An image forming apparatus 201 is a laser beam printer of a tandem intermediate-transfer type using an electrophotographic process. The image forming apparatus 201 forms a full-color image or a monochrome image on a recording material S being a recording medium and outputs the recording material S based on image data acquired from an external device 1000 (see FIG. 1) via a network or based on image data acquired from an image reading device 202 which is provided on the top of the image forming apparatus 201.

The image forming apparatus 201 has, inside a main body 201A, components for forming an image, and includes, on the top of the main body 201A, the image reading device 202 and an operation unit 502 having the same configuration as the operation unit 110 of FIG. 1. A delivery space D including a placement portion 223 for receiving the recording material S to be delivered thereinto after image formation is defined between the main body 201A of the image forming apparatus 201 and the image reading device 202.

The image reading device 202 is a scanner which reads an image from an original to generate image data. The image reading device 202 is used, for example, at the time of processing of copying an original. The image reading device 202 in the at least one embodiment is configured as a part of the image forming apparatus 201. The image reading device 202 is not limited to this configuration, and the image reading device 202 may be configured to be electrically connected to the image forming apparatus 201 as a device different from the image forming apparatus 201.

The image forming apparatus 201 includes, in the main body 201A, an image forming mechanism 201B, an intermediate transfer unit 201C, a secondary transfer unit 201D, a fixing device 201E, and cassette feeding units 230. The main body 201A includes a manual feeding unit 235.

The cassette feeding units 230 each feed recording materials S from a corresponding one of feeding cassettes 231 accommodating the recording materials S. The cassette feeding unit 230 includes a pickup roller 232 and a separation unit for separating recording materials S sent out from the pickup roller 232, the separation unit including a feed roller 233 and a retard roller 234. The recording materials S are fed one by one from the feeding cassette 231 by the pickup roller 232 and the separation unit. In the at least one embodiment, description is given of a configuration in which a plurality of (in this example, four) cassette feeding units 230 are provided. However, any number of cassette feeding units 230 may be provided. The recording material S fed from the cassette feeding unit 230 is conveyed to registration rollers 240 via conveyance rollers 280 and 290. A detector 115 similar to that of the image forming apparatus 100 is arranged between the conveyance rollers 280 and the conveyance rollers 290 in order to detect the actual sheet length of the recording material S.

The recording material S can be fed from a unit other than the cassette feeding unit 230, that is, from the manual feeding unit 235. The manual feeding unit 235 includes a tray 236 for receiving recording materials S manually placed by the user. Similar to the cassette feeding unit 230, the manual feeding unit 235 includes a pickup roller and a separation unit, and recording materials S are fed one by one from the tray 236. The recording material S fed from the manual feeding unit 235 is also conveyed to the registration rollers 240 via the conveyance rollers 280 and 290.

The image forming mechanism 201B is of a four-drum full-color type, and includes a laser scanner 210 and four image forming units 211. The four image forming units 211 form toner images of four colors, specifically, yellow (Y), magenta (M), cyan (C), and black (K). Each image forming unit 211 includes a photosensitive drum 212, a charging device 213, and a developing device 214. Toner cartridges 215 are arranged above the image forming units 211. The toner cartridges 215 replenish the respective developing devices 214 with toner.

The intermediate transfer unit 201C includes an intermediate transfer belt 216 wound around a drive roller 216a and a tension roller 216b. On an inner side of the intermediate transfer belt 216, there are provided four primary transfer rollers 219 which are in abutment against the intermediate transfer belt 216 at positions opposing the photosensitive drums 212. The intermediate transfer belt 216 is rotated in the direction of an arrow R3 by the drive roller 216a driven by a drive unit (not shown).

The secondary transfer unit 201D includes a secondary transfer roller 217 provided so as to sandwich the intermediate transfer belt 216 at a position opposing the drive roller 216a. The fixing device 201E is provided on a downstream side of the secondary transfer roller 217 in the conveyance direction of the recording material S, and includes a pressure roller 220a and a heating roller 220b. On a downstream side of the fixing device 201E in the conveyance direction of the recording material S, there are arranged first delivery rollers 225a, second delivery rollers 225b, and a duplex-printing reversing unit 201F. The duplex-printing reversing unit 201F includes reversing rollers 222 and a re-conveyance passage R. The reversing rollers 222 are rotatable in forward and reverse directions. The re-conveyance passage R allows the recording material S having an image formed on one side thereof to be conveyed to the image forming mechanism 201B.

The image forming apparatus 201 having the configuration as described above operates as follows. The image forming apparatus 201 acquires, together with an instruction to start a print job, image data from the image reading device 202 or from the external device 1000 and forms an image corresponding to the image data on the recording material S. A print job is a series of operations performed based a print signal instructing an image to be formed on the recording material S, in which a conveyance process and an image forming process are executed, and after the image printing is complete, the recording material S is delivered to the placement portion 223. The image forming apparatus 201 acquires the instruction to start the print job from the operation unit 502 or the external device 1000.

The image forming mechanism 201B uses the charging device 213 to uniformly charge surfaces of the photosensitive drums 212 to an electric potential having a predetermined polarity. The laser scanner 210 irradiates the uniformly charged surfaces of the photosensitive drums 212 with corresponding laser beams modulated based on the image data. In this way, electrostatic latent images for corresponding colors (yellow, magenta, cyan, and black) are formed on the respective surfaces of the photosensitive drums 212.

The image forming mechanism 201B uses the developing devices 214 to develop the electrostatic latent images formed on the photosensitive drums 212. The electrostatic latent images are developed on the photosensitive drums 212 with toners of corresponding colors so that toner images of the corresponding colors are formed on the photosensitive drums 212. The toner images are sequentially transferred from the photosensitive drums 212 to the rotating intermediate transfer belt 216 in superimposition by the primary transfer rollers 219. In this way, a full-color toner image is formed on the intermediate transfer belt 216. The intermediate transfer belt 216 rotates to convey the toner image to the secondary transfer unit 201D.

Concurrently with such operation of forming a toner image, the recording materials S are conveyed one by one by the cassette feeding unit 230 or the manual feeding unit 235 to the registration rollers 240. The registration rollers 240 correct skew of the recording material S conveyed to the registration rollers 240. After the skew is corrected, the recording material S is conveyed by the registration rollers 240 to the secondary transfer unit 201D in synchronization with the timing at which the toner image borne on the intermediate transfer belt 216 is conveyed to the secondary transfer unit 201D. The secondary transfer unit 201D transfers the full-color toner image from the intermediate transfer belt 216 onto the recording material S with secondary transfer bias applied to the secondary transfer roller 217.

The recording material S having the toner image transferred thereto is conveyed to the fixing device 201E. The fixing device 201E sandwiches and conveys the recording material S with a roller nip portion defined by the pressure roller 220a and the heating roller 220b. The fixing device 201E heats the recording material S with the heating roller 220b at the time of sandwiching and conveying the recording material S, to thereby melt and mix the toners of respective colors on the recording material S. Further, the fixing device 201E presses the recording material S toward the heating roller 220b with the pressure roller 220a, to thereby fix the melted and mixed toners to the recording material S. At this time, the viscosity of the melted toner generates a sticking force to the heating roller 220b on the recording material S.

The recording material S having the image fixed thereto is delivered to the delivery space D by any one of the first delivery rollers 225a and the second delivery rollers 225b. The recording material S is placed on the placement portion 223 provided in a protruding manner on a bottom surface of the delivery space D. When images are formed on both surfaces of the recording material S, the recording material S having an image fixed on one surface thereof is conveyed by the reversing rollers 222 to the re-conveyance passage R. The recording material S is conveyed again to the image forming mechanism 201B, and an image is formed on another surface of the reversed recording material S. The re-conveyance passage R allows the recording material S to be conveyed to the conveyance path between the conveyance roller 290 and the registration rollers 240.

In this way, in the image forming apparatus 201, the recording material S is conveyed along a conveyance path (vertical path) extending in the vertical direction. During image formation, the recording material S is conveyed from a lower side toward an upper side in the vertical direction from the registration rollers 240 to the fixing device 201E, with the upper side as the leading edge. When conveyed through the re-conveyance passage R, the recording material S is conveyed from the upper side toward the lower side in the vertical direction, with the lower side as the leading edge.

Operation of the image forming apparatus 201 is controlled by the main controller 101, which is the same as that illustrated in FIG. 3. In this case, the placement portion 124 of the printer 120 includes the cassette feeding units 230 and the manual feeding unit 235. The conveyance unit 123 includes various rollers such as the conveyance rollers 280 and 290, and the registration rollers 240. The fixing unit 122 includes the fixing device 201E. The image forming unit P includes the image forming unit 211.

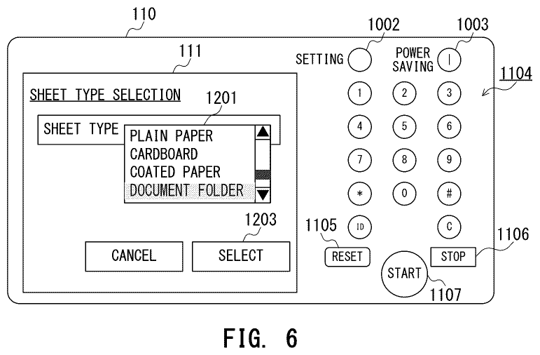

In the at least one embodiment, printing on a document folder is possible by selecting the type of sheet (recording material S) to be used for printing from a sheet type selection screen. FIG. 6 is an exemplary view of the sheet type selection screen. A selection screen 1201 is displayed on the display 111. On the selection screen 1201, the recording material S type can be freely selected, and document folder is provided as one of those freely-selectable sheet types.

When the user selects and presses document folder from a pull-down menu on the selection screen 1201, the selected portion is displayed with its background being highlighted. When the user subsequently presses a select button 1203, the selection of document folder as the sheet type is input to the main controller 101. The CPU 102 thereby sets the type of the recording material S to document folder.

Setting information (image forming conditions) corresponding to document folder to be used at the time of image formation to prevent deterioration in conveyance performance and image quality is stored in the ROM 103 in advance. The CPU 102 acquires the setting information on document folder from the ROM 103, and uses the acquired setting information for control during image formation by the printer 120. As a result, deterioration in conveyance performance due to jamming or the like in a case where printing on a document folder is prevented. Further, the ROM 103 stores, as the standard sizes, the sheet length of the standard size sheet and the sheet length of the document folder which accommodates the sheet. That is, two sheet lengths are associated with one standard size.

### First Embodiment

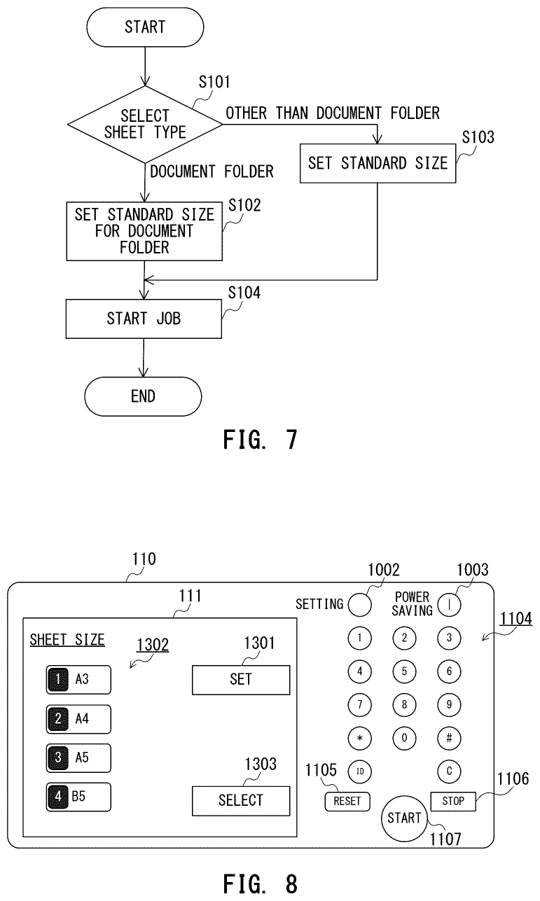

Description is given of a case in which an image is printed using a document folder as the recording material S. FIG. 7 is a flowchart for illustrating processing up to the start of image forming processing. In this processing, the sheet length is changed in accordance with the type of the recording material S even when a standard size is set. For example, in a case where a document folder having an A4 standard size is set for the recording material S, the sheet length is changed to a longer sheet length than in the case of a normal A4 standard size.

The main controller 101 determines, based on the sheet type setting, whether or not document folder is set as the recording material S (Step S101). The sheet type setting is performed on the selection screen 1201 illustrated in FIG. 6 described above. A case in which document folder is set is referred to as “first mode,” and a case in which a single sheet not having a fixed portion and an open portion (not having a closed side) other than a document folder is set is referred to as “second mode.”

When document folder is set as the recording material S (Step S101: Y), the main controller 101 sets the standard size for document folder. FIG. 8 is an exemplary view of a standard size setting screen displayed on the display 111. A setting screen 1302 displays a list of standard sizes for document folders stored in the ROM 103. The user selects the standard size for the document folder corresponding to the recording material S from the setting screen 1302 by using the operation unit 110, and presses the select button 1303. The main controller 101 sets the standard size (sheet length) for the document folder selected from the setting screen 1302 by pressing the select button 1303. The setting content is stored in the RAM 104, for example. When a corresponding standard size is not displayed on the setting screen 1302, the user can press the setting button 1301 to set the sheet length of the recording material S by using the hard key group 1104.

When document folder is not set as the recording material S (Step S101: N), the main controller 101 sets the standard size for a general sheet (Step S103). The standard size setting screen in this case is the same as that of FIG. 8. The setting screen 1302 displays a list of standard sizes for sheets stored in the ROM 103. The user selects the standard size corresponding to the recording material S from the setting screen 1302 by using the operation unit 110, and presses the select button 1303. The main controller 101 sets the standard size (sheet length) for the sheet selected from the setting screen 1302 by pressing the select button 1303. The setting content is stored in the RAM 104, for example. When a corresponding standard size is not displayed on the setting screen 1302, the user can press the setting button 1301 to set the sheet length of the recording material S by using the hard key group 1104.

Even when the standard size is the same, the sheet length set in the processing step of Step S102 is longer than the sheet length set in the processing step of Step S103. This is because the sheet length of a document folder is set in the processing step of Step S102, and the document folder can accommodate paper of the same standard size.

After the setting of the size is complete, in a case where the start key 1107 of the operation unit 110 is pressed, the main controller 101 starts the job (Step S104). The main controller 101 determines the jam reference length from the set size (sheet length), and uses the conveyance unit 123 to convey the recording material S at an inter-sheet distance corresponding to the jam reference length. As a result, even when the recording material S is a document folder, the image is printed while the occurrence of jamming is prevented.

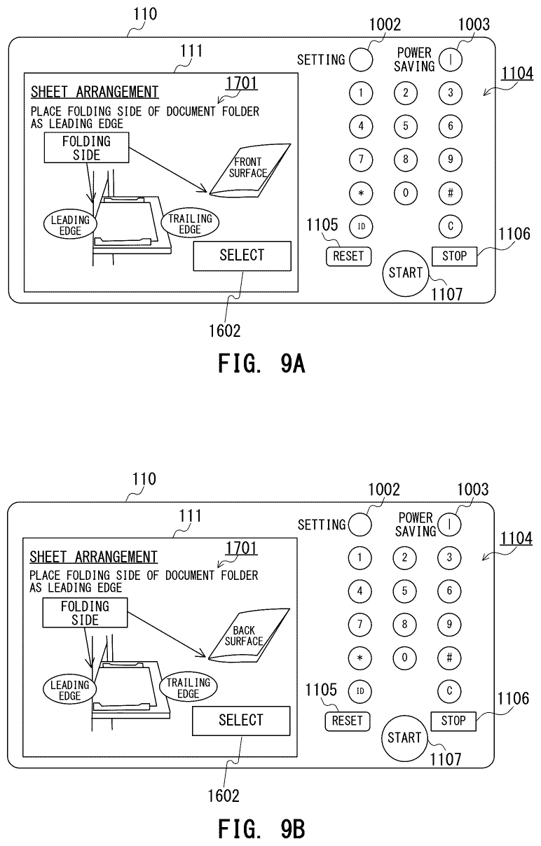

When an image is formed on a document folder, the document folder is placed on the tray 17 before the job is started. At this time, the main controller 101 may display a guide screen on the display 111 to provide guidance regarding the orientation of the document folder during placement. FIG. 9A and FIG. 9B are exemplary views of such a guide screen. A guide screen 1701 of each of FIG. 9A and FIG. 9B includes an instruction for the printing surface in addition to the instruction to place the folded portion of the document folder to be placed on the tray 17 as the leading edge side in the conveyance direction. Here, the printing surface is referred to as “front surface.”

The guide screen 1701 of FIG. 9A includes a message prompting the user to place the document folder so that the front surface is facing upward, with the folded portion of the document folder as the leading edge side in the conveyance direction. The image forming apparatus 100 prints an image while conveying the recording material S along the horizontal path extending in the horizontal direction. In this case, the image is printed on the front surface of the document folder by placing the document folder on the tray 17 with the front surface, which is the printing surface, facing upward.

The guide screen 1701 of FIG. 9B includes a message prompting the user to place the document folder so that the back surface is facing upward, with the folded portion of the document folder as the leading edge side in the conveyance direction. The image forming apparatus 201 prints an image while conveying the recording material S along the vertical path extending in the vertical direction. In this case, the image is printed on the front surface of the document folder by placing the document folder on the tray 236 with the front surface, which is the printing surface, facing downward.

During duplex printing, similarly to during simplex printing, the main controller 101 may display, on the display 111, a guide screen which provides guidance regarding the orientation in a case where the recording material S is placed. Examples of the guide screen are illustrated in FIG. 9A and FIG. 9B. In the case of performing duplex printing, in a case where an image is formed on the first surface, the document folder is temporarily conveyed out from the image forming apparatus 100. Then, the printing surface (image forming surface) is reversed to the second surface, and the document folder is again placed on the tray 17. The guide screen is the same as that displayed in a case where simplex printing is performed, but the meaning of the guide screen is different.

The guide screen 1701 of FIG. 9A includes a message prompting the user to place the document folder so that the front surface (first surface) is facing upward, with the folded portion of the document folder as the leading edge side in the conveyance direction and the closed portion as the far side. The guide screen 1701 of FIG. 9A is displayed in a case where an image is formed on the first surface. The guide screen 1701 of FIG. 9B includes a message prompting the user to place the document folder so that the back surface (second surface) is facing upward, with the folded portion of the document folder as the leading edge side in the conveyance direction and the closed portion as the near side. The guide screen 1701 of FIG. 9B is displayed in a case where an image is formed on the second surface after the printing on the first surface is complete. As used herein, “near side” and “far side” are directions orthogonal to the conveyance direction, with the front side of the image forming apparatus 100 being the near side and the back side of the image forming apparatus 100 being the far side.

This instruction is a message used in a case where a document folder is placed on the tray 17 of the image forming apparatus 100. When a document folder is placed on the tray 236 of the image forming apparatus 201, the message includes the opposite instruction for the front surface and the back surface. That is, in a case where the image forming apparatus 201 is used, the guide screen 1701 of FIG. 9B is displayed in a case where an image is formed on the first surface, and the guide screen 1701 of FIG. 9A is displayed in a case where an image is formed on the second surface.

Thus, the guide screen 1701 includes a message for placing the document folder on the tray 17 or 236 so that a fixed portion of the document folder is on the leading edge side in the conveyance direction. When a document folder is conveyed with an open portion on the leading edge side, jamming may occur. The possibility of jamming can be prevented by conveying the document folder with a fixed portion on the leading edge side.

Further, when performing duplex printing, the main controller 101 may display an instruction screen illustrated as an example in FIG. 10 on the display 111. This instruction screen is displayed on the display 111 at the start of a job or in a case where image formation on the first surface is complete and the document folder has been conveyed out from the image forming apparatus 100. When the main controller 101 detects that the printing on the front surface (first surface) is complete and the document folder is placed on the tray 17, the main controller 101 deletes the instruction screen of FIG. 10 from the display 111 and performs printing on the back surface (second surface).

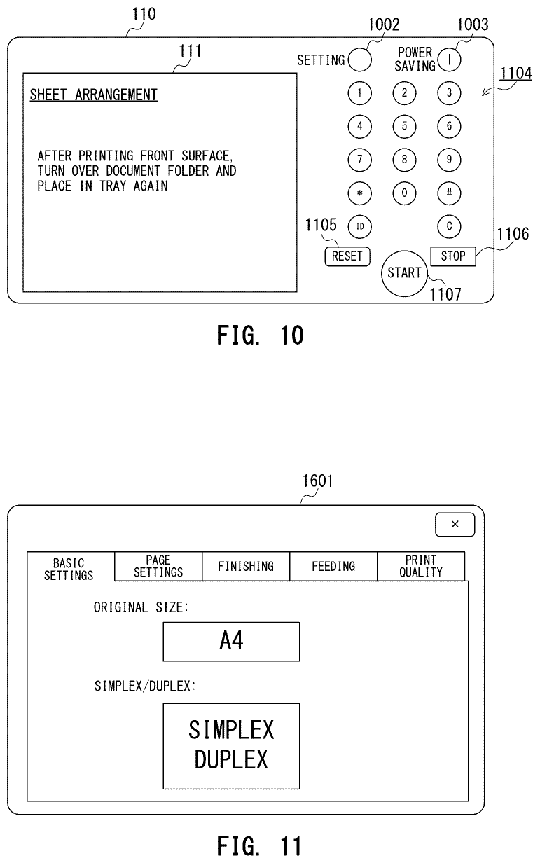

In a first embodiment of the present disclosure, description is given of an example in which various settings related to printing are performed by the user operating the operation unit 110, but it is possible to perform the same processing even when the user operates the external device 1000. The external device 1000 is an information processing device which includes an input device and a display. The external device 1000 has the functions of the main controller 101, and a printer driver for using the image forming system 1X, for example, is installed in the external device 1000. On the display of the external device 1000, the printer driver displays screens for selecting the items to be set on each of the screens of FIG. 6 and FIG. 8 in accordance with the progress of the processing. Further, the guide screens of FIG. 9A and FIG. 9B and the instruction screen of FIG. 10 may be displayed on the display of the external device 1000 in accordance with the progress of the processing. FIG. 11 is an exemplary view of an original size and duplex printing setting screen displayed on a display 1502 of the external device 1000. Even when the setting is performed by using the external device 1000, it is possible to print on the document folder.

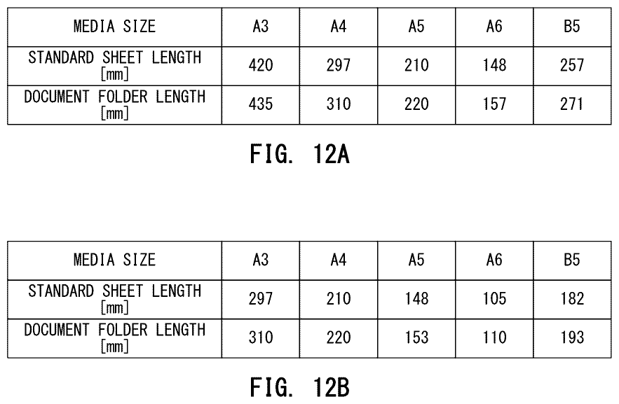

The effect of the ROM 103 storing the sheet length corresponding to the standard size for the document folder in addition to the sheet length of the standard size sheet was verified. In the verification, a document folder was used as the recording material S, and whether or not a sheet could be passed was verified by varying the setting of the standard size. FIG. 12A and FIG. 12B are explanatory tables of the verification results.

In FIG. 12A, the sheet length in a case where the recording material S is conveyed so that the long sides thereof are in the conveyance direction is shown. As the sheet length of each size (media size) from A3 to B5, the sheet length of the sheet (standard paper length) and the sheet length of the document folder (document folder length) are stored in the ROM 103. In FIG. 12B, the sheet length in a case where the recording material S is conveyed so that the short sides thereof are in the conveyance direction is shown. As the sheet length of each size (media size) from A3 to B5, the sheet length of the sheet (standard paper length) and the sheet length of the document folder (document folder length) are stored in the ROM 103.

When the recording material S was a document folder and the sheet length was the standard paper length, jamming was detected, but in a case where the sheet length was the document folder length, jamming was not detected. This result shows that regardless of whether or not the conveyance direction is the long side or the short side of the recording material S, jamming is not detected in a case where the sheet length for document folder is set. That is, in a case where document folder is selected as the recording material S on the selection screen 1201 of FIG. 6 and the sheet size is set on the setting screen 1302 of FIG. 8, detection of jamming is prevented in a case where the sheet size is set to be larger than the standard size of the sheet.

### Second Embodiment

Description is given of a case in which an image is printed by using a document folder as the recording material S. In the first embodiment, standard sizes (sheet lengths) are prepared separately for sheets and document folders. In a second embodiment of the present disclosure, the occurrence of jamming is prevented by adjusting a jam margin in accordance with the type of the recording material S. FIG. 13 is a flowchart for illustrating processing up to the start of the image forming processing in the second embodiment.

The main controller 101 displays the sheet type selection screen of FIG. 6 on the display 111, and prompts the user to select the sheet type (Step S201). The main controller 101 acquires information indicating the sheet type selection result from the operation unit 110. The main controller 101 displays the standard size setting screen of FIG. 8 on the display 111, and prompts the user to select the standard size (Step S202). The main controller 101 acquires information indicating the standard size selection result from the operation unit 110. The standard size in this case is the standard size of the sheet, not the standard size of the document folder. As a result, the sheet length of the recording material S is set.

The main controller 101 determines whether or not the sheet type selected in Step S201 is document folder (Step S203). A case in which document folder is set is referred to as “first mode,” and a case in which a single sheet not having a fixed portion and an open portion (not having a closed side) other than a document folder is set is referred to as “second mode.” When the sheet type is document folder (Step S203: Y), the main controller 101 changes the jam margin to a value corresponding to document folder (Step S204). Specifically, the jam margin is changed to a larger value than in the case of the sheet. The main controller 101 starts the job in a case where the start key 1107 of the operation unit 110 is pressed (Step S205). When the sheet type is not document folder (Step S203: N), the main controller 101 does not change the jam margin, and starts the job in a case where the start key 1107 of the operation unit 110 is pressed (Step S205). The jam margin is changed depending on the size of the recording material S. For example, in a case where the size of the recording material S is larger, a larger jam margin is set.

Similar to the first embodiment, in a case where an image is formed on a document folder, the guide screen illustrated as an example in FIG. 9A and FIG. 9B may be displayed on the display 111 before the job is started. Further, in the case of duplex printing, the instruction screen illustrated as an example in FIG. 10 may be displayed on the display 111.

The main controller 101 determines the jam reference length from the set jam margin, and uses the conveyance unit 123 to convey the recording material S at the inter-sheet distance corresponding to the jam reference length. When the sheet type of the recording material S is document folder, the jam margin has a value corresponding to the document folder, and hence the jam reference length is longer than in the case of the sheet. As a result, even when the recording material S is a document folder, the image is printed while jam detection is prevented.

Similarly to the first embodiment, it is also possible in the second embodiment for the user to perform various settings relating to printing by operating the external device 1000. On the display of the external device 1000, the printer driver displays screens for setting the items to be set on each of the screens of FIG. 6 and FIG. 8 in accordance with the progress of the processing. Further, the guide screen of FIG. 9A and FIG. 9B, the instruction screen of FIG. 10, and the setting screen of FIG. 11 may be displayed on the display of the external device 1000 in accordance with the progress of the processing. Even when the setting is performed by using the external device 1000, it is possible to print on the document folder.

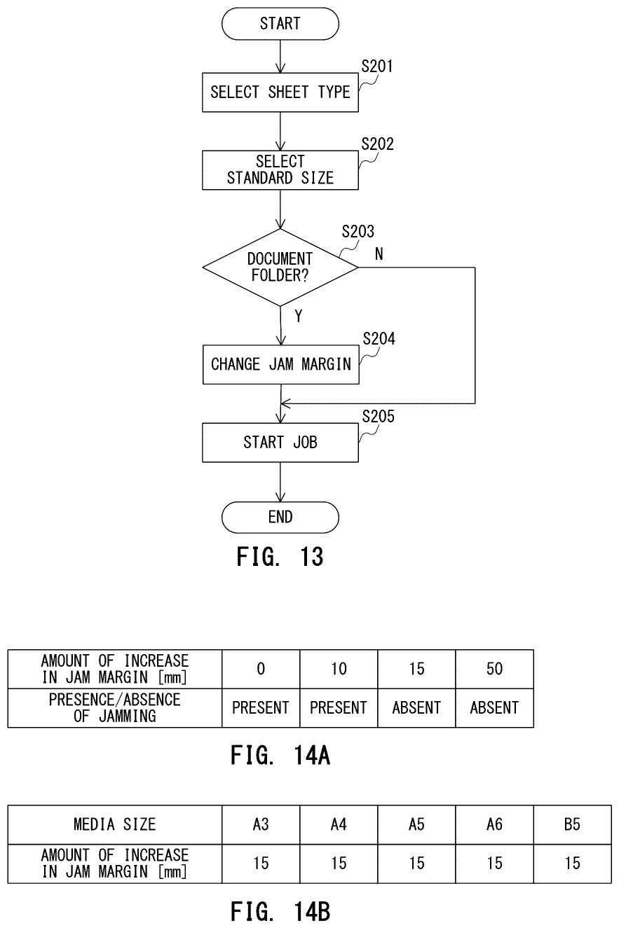

The effect gained by the above-mentioned processing of changing the jam margin was verified. Here, an A4 standard size document folder was used as the recording material S, and whether or not a sheet could be passed was verified by using different jam margins. FIG. 14A and FIG. 14B are explanatory tables of the verification results.

In FIG. 14A, the amount of increase in the jam margin and the results of whether or not jamming occurred are shown. It is shown that the occurrence of jamming is prevented and a sheet can be passed by increasing the jam margin. In FIG. 14B, the amount of increase in the jam margin at which jamming did not occur in a case where a standard size document folder of each size (media size) from A3 to B5 was passed is shown. It is noted that the amount of increase in the jam margin is an example, and for each size, the sheet can be passed in a case where the amount of increase is between 5 mm and 25 mm. That is, the results show that it is required to set a jam margin corresponding to the size of the document folder.

As described above in the first embodiment and the second embodiment, with the adjustment of the jam margin, even when the recording material S is larger than the standard size, such as in the case of a document folder, it is possible to reduce the possibility of determining that a conveyance failure has occurred.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-064420, filed Apr. 12, 2024, which is hereby incorporated by reference herein in its entirety.

What is claimed is:

1. An image forming apparatus comprising:
an operation unit configured to allow selection between a first mode for forming an image on a first recording material in which at least one side is closed and a second mode for forming an image on a second recording material without a closed side, and to allow input of information relating to a size of a recording material;
an image former configured to form an image on the recording material; and
a controller configured to set, in a case where the first mode is selected through the operation unit and a first size is input as information relating to a size of the first recording material, a length of the first recording material in a conveyance direction as a first length, and in a case where the second mode is selected through the operation unit and the first size is input as information relating to a size of the second recording material, a length of the second recording material in the conveyance direction as a second length,
wherein the first length is longer than the second length.

2. The image forming apparatus according to claim 1, wherein the controller is configured to set a first inter-sheet distance during conveyance of the first recording material in a case where the first mode is selected through the operation unit to be larger than a second inter-sheet distance during conveyance of the second recording material in a case where the second mode is selected through the operation unit.

3. The image forming apparatus according to claim 2, wherein the controller is configured to determine an inter-sheet distance based on a reference length obtained by adding a first sheet length of the recording material in the conveyance direction set through the operation unit to an allowable amount of a difference between the first sheet length and a second sheet length in the conveyance direction of an actual recording material.

4. The image forming apparatus according to claim 3, wherein the allowable amount in a case where the first mode is selected through the operation unit is larger than the allowable amount in a case where the second mode is selected through the operation unit.

5. The image forming apparatus according to claim 1, wherein the controller is configured to:
display, in a case where the first mode is selected through the operation unit, a setting screen for setting a standard size of the recording material on a display, and set the first length based on the standard size set from the setting screen through the operation unit; and
display, in a case where the second mode is selected through the operation unit, the setting screen on the display, and set the second length based on the standard size set from the setting screen through the operation unit.

6. The image forming apparatus according to claim 5, further comprising a memory configured to store the first length corresponding to a standard size of the first recording material and the second length corresponding to a standard size of the second recording material,
wherein the controller is configured to:
acquire, in a case where the first mode is selected through the operation unit, the first length of the first recording material from the memory based on the standard size set from the setting screen through the operation unit, and
acquire, in a case where the second mode is selected through the operation unit, the second length of the second recording material from the memory based on the standard size set from the setting screen through the operation unit.

7. An image forming apparatus comprising:
an operation unit configured to allow selection between a first mode for forming an image on a first recording material in which at least one side is closed and a second mode for forming an image on a second recording material without a closed side, and to allow input of information relating to a size of a recording material;
an image former configured to form an image on the recording material; and
a controller configured to determine an inter-sheet distance during conveyance based on a reference length obtained by adding a first sheet length of the recording material in a conveyance direction set through the operation unit to an allowable amount of a difference between the first sheet length and a second sheet length in the conveyance direction of an actual recording material,
wherein the allowable amount in a case where the first mode is selected through the operation unit is larger than the allowable amount in a case where the second mode is selected through the operation unit.

8. The image forming apparatus according to claim 7, wherein the controller is configured to change the allowable amount in accordance with the size of the recording material.

9. The image forming apparatus according to claim 7, wherein the controller is configured to display, in a case where one of the first mode and the second mode is selected through the operation unit, a setting screen for setting a standard size of the recording material on a display, and to acquire the first sheet length based on the standard size set from the setting screen through the operation unit.

10. The image forming apparatus according to claim 7, wherein the controller is configured to detect jamming in a case where the second sheet length is longer than the reference length.

11. The image forming apparatus according to claim 7, further comprising a detector provided on a conveyance path for the recording material, the detector being configured to detect a length of the recording material in a conveyance direction,
wherein the controller is configured to acquire the second sheet length by using the detector.

12. The image forming apparatus according to claim 1, wherein the first recording material is a document folder made of a plastic material and formed in a bag shape.

13. The image forming apparatus according to claim 7, wherein the first recording material is a document folder made of a plastic material and formed in a bag shape.

14. An information processing device which is communicably connected to an image forming apparatus configured to form an image on a recording material, the information processing device comprising:
an operation unit configured to allow input of information relating to a size of a recording material, and to allow selection between a first mode for forming an image on a first recording material in which at least one side is closed and a second mode for forming an image on a second recording material without a closed side; and
a controller configured to set, in a case where the first mode is selected through the operation unit and a first size is input as information relating to a size of the first recording material, a length of the first recording material in a conveyance direction as a first length, and in a case where the second mode is selected through the operation unit and the first size is input as information relating to a size of the second recording material, a length of the second recording material in the conveyance direction as a second length,
wherein the first length is longer than the second length.

15. An information processing device which is communicably connected to an image forming apparatus configured to form an image on a recording material, the information processing device comprising:
an operation unit configured to allow input of information relating to a size of a recording material, and to allow selection between a first mode for forming an image on a first recording material in which at least one side is closed and a second mode for forming an image on a second recording material without a closed side; and
a controller configured to determine an inter-sheet distance based on a reference length obtained by adding a first sheet length of the recording material in a conveyance direction set through the operation unit to an allowable amount of a difference between the first sheet length and a second sheet length in the conveyance direction of an actual recording material,
wherein the allowable amount in a case where the first mode is selected through the operation unit is a value larger than the allowable amount in a case where the second mode is selected through the operation unit.
